(19) United States
(12) Patent Application Publication
(10) Pub. No.: US 2023/0040623 A1
(43) Pub. Date: Feb. 9, 2023

(54) DEEP REINFORCEMENT LEARNING APPARATUS AND METHOD FOR PICK-AND-PLACE SYSTEM

(71) Applicant: AGILESODA INC., Seoul (KR)

(72) Inventors: Pham-Tuyen LE, Suwon-si (KR); Dong Hyun LEE, Seongnam-si (KR); Dae-Woo CHOI, Seoul (KR)

(73) Assignee: AGILESODA INC., Seoul (KR)

(21) Appl. No.: 17/867,001

(22) Filed: Jul. 18, 2022

(30) Foreign Application Priority Data
Aug. 5, 2021 (KR) 10-2021-0103263

(51) Int. Cl. B25J 9/16

(52) U.S. Cl. CPC B25J 9/163; B25J 9/1671; B25J 9/1687; B25J 9/1664; B25J 9/161; B25J 9/1682

(57) ABSTRACT

Disclosed is a deep reinforcement learning apparatus and method for a pick-and-place system. According to the present disclosure, a simulation learning framework is configured to apply reinforcement learning to make pick-and-place decisions using a robot operating system (ROS) in a real-time environment, thereby generating stable path motion that meets various hardware and real-time constraints.

### CROSS-REFERENCE TO RELATED APPLICATION(S)

This application is based on and claims priority under 35 U.S.C. 119 to Korean Patent Application No. 10-2021-0103263, filed on Aug. 5, 2021, in the Korean Intellectual Property Office, the disclosure of which is herein incorporated by reference in its entirety.

### BACKGROUND

### 1. Field

The present disclosure relates to an apparatus and a method for deep reinforcement learning for a pick-and-place system and, more specifically, to an apparatus and a method for deep reinforcement learning for a pick-and-place system, wherein a simulation learning framework is configured such that reinforcement learning can be applied to make pick-and-place decisions using a robot operating system (ROS) in a real-time environment, thereby generating a stable path motion that meets various hardware and real-time constraints.

### 2. Description of Prior Art

Reinforcement learning refers to a learning method that handles agents for accomplishing objectives while interacting with environments, and is widely used in fields related to robots or artificial intelligence.

The objective of such reinforcement learning is to find out which action the reinforcement learning agent (protagonist of learning) should take to receive more rewards.

That is, even when no fixed answer is given, it is learned what is to be done to maximize rewards. It is not following actions heard in advance in a situation having a clear relation between inputs and outputs, but learning to maximize rewards through trial and error.

In addition, the agent successively selects actions as time steps pass, and is rewarded based on influences of the actions on environments.

FIG. 1 is a block diagram illustrating the configuration of a reinforcement learning apparatus according to the prior art. As illustrated in FIG. 1, an agent 10 learns a method for determining an action (or behavior) A by learning a reinforcement learning model, each action A affects the next state S, and the degree of success is measurable in terms or a reward R.

That is, the reward is a compensation score in relation to an action determined by the agent 10 according to a specific state when learning proceeds through a reinforcement learning model, and is a kind of feedback regarding an intention determined by the agent 10 as a result of learning.

The environment 20 is a set of rules regarding actions that the agent 10 may take and resulting rewards. States, actions, and rewards constitute the environment. Everything determined, except for the agent 10, constitutes the environment.

Meanwhile, the agent 10 takes actions to maximize future rewards through reinforcement learning, and the rewarding policy has a large influence on the learning result.

Such reinforcement learning operates as a core function for automatically updating factory automation using robots without human interventions.

Meanwhile, pick-and-place systems (PPS) have been used for factory manufacturing processes to replace human resources, but there is a problem in that it is difficult to develop an integrated system for improving the system accuracy and performance.

There is another problem in that, when manufacturing processes are frequently changed, updates regarding new processes are necessary to optimize the performance, and many parameters to be considered in this connection constitute multiple modules and complicate the system, making it difficult to develop a framework for PPS design.

### SUMMARY

In order to solve the above-mentioned problems, it is an aspect of the present disclosure to provide an apparatus and a method for deep reinforcement learning for a pick-and-place system, wherein a simulation learning framework is configured such that reinforcement learning can be applied to make pick-and-place decisions using a robot operating system (ROS) in a real-time environment, thereby generating a stable path motion that meets various hardware and real-time constraints.

In accordance with an aspect, a deep reinforcement learning apparatus for a pick-and-place system according to an embodiment of the present disclosure may include: a rendering engine configured to perform simulation based on a received path according to the movement of one or more robots while requesting a path between the parking position and placement position of the robots with respect to a provided action and to provide state information and reward information to be used for reinforcement learning; a reinforcement learning agent configured to perform deep reinforcement learning based on an episode using the state information and reward information provided from the rendering engine to determine an action so that the movement of the robots is optimized; and a control engine configured to control the robots to move based on the action and to provide path information according to the movement of the robots to the rendering engine in response to the request of the rendering engine.

In addition, according to the embodiment, the reinforcement learning agent may determine an action for assigning information indicating whether to pick up an arbitrary object to a specific robot through current states of the robots and information of selectable objects.

In addition, according to the embodiment, the path information according to the movement of the robots may be any one of a path in which the robots move in a real environment and a path in which the robots move in a pre-stored simulator program.

In addition, according to the embodiment, in the rendering engine, an application program to perform visualization through a web may be additionally installed.

In addition, according to the embodiment, the reinforcement learning agent may perform a delayed reward processing in response to a delayed reward.

In addition, according to the embodiment, the reinforcement learning agent may include a long short term memory (LSTM) layer for considering the uncertainty in the simulation and the moving object.

In addition, according to the embodiment, the reinforcement learning agent may learn to select an entity with a probability value that will generate the shortest pick-and-place time period.

In addition, a deep reinforcement learning method for a pick-and-place system according to an embodiment of the present disclosure may include: a) requesting and collecting, by a reinforcement learning agent, state information and reward information on an action to be used for reinforcement learning from a rendering engine; b) performing, by the reinforcement learning agent, deep reinforcement learning based on an episode using the collected state information and reward information to determine an action so that the movement of one or more robots is optimized; c) controlling, by a control engine, the robots to move based on the action when the rendering engine outputs the determined action; and d) receiving, by the rendering engine, path information of the robots to perform simulation based on a path according to the movement.

In addition, according to the embodiment, the b) performing of the deep reinforcement learning may include determining an action for assigning information indicating whether to pick up an arbitrary object to a specific robot through current states of the robots and selectable objects.

In addition, according to the embodiment, the information collected in the a) requesting and collecting of the state information and reward information may be movement information of the robots including a path between the parking position and placement position of the robots.

In addition, according to the embodiment, the b) performing of the deep reinforcement learning may include performing a delayed reward processing in response to a delayed reward.

In addition, according to the embodiment, the b) performing of the deep reinforcement learning may include selecting, by the reinforcement learning agent, an entity with a probability value that will generate the shortest pick-and-place time period.

In addition, according to the embodiment, the c) controlling of the robots may include controlling, by the control engine, the robots to move in a real environment and on a pre-stored simulator program and extracting a movement path corresponding to the simulator program.

According to the present disclosure, a reinforcement learning agent, a rendering engine, and a control engine may constitute a simulation learning framework, and reinforcement learning may be applied to make pick-and-place decisions using a robot operating system (ROS) in a real-time environment.

An artificial intelligence model generated through reinforcement learning of such a simulation learning framework may be used for a pick-and-place system, thereby implementing a stable path motion that meets various hardware and real-time constraints.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram illustrating the configuration of a general reinforcement learning apparatus.

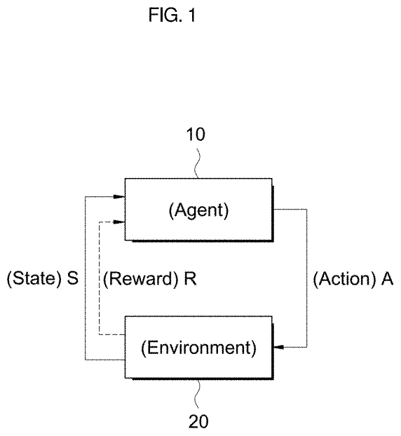

FIG. 2 is a block diagram schematically illustrating a deep reinforcement learning apparatus for a pick-and-place system according to an embodiment of the present disclosure.

FIG. 3 is a block diagram illustrating the configuration of the deep reinforcement learning apparatus for the pick-and-place system according to the embodiment of FIG. 2.

FIG. 4 is an exemplary diagram illustrating the pick-and-place system of the deep reinforcement learning apparatus for the pick-and-place system according to the embodiment of FIG. 2.

FIG. 5 is a flowchart illustrating a deep reinforcement learning method for a pick-and-place system according to an embodiment of the present disclosure.

FIG. 6 is a flowchart illustrating an episode configuration process of a deep reinforcement learning method for a pick-and-place system according to the embodiment of FIG. 5.

### DETAILED DESCRIPTION

Hereinafter, the present disclosure will be described in detail with reference to preferred embodiments of the present disclosure and the accompanying drawings. The same reference numerals in the drawings will be described on the premise that they refer to the same components.

Prior to describing the specific contents for carrying out the present disclosure, it should be noted that components not directly related to the technical gist of the present disclosure are omitted within the scope of not disturbing the technical gist of the present disclosure.

In addition, terms or words used in this specification and claims should be interpreted as meaning and concept consistent with the technical idea of the present disclosure based on the principle that inventors can define concepts in terms appropriate to the best way to describe their invention.

In the present specification, the expression that a part “includes” a certain element does not exclude other elements, but means that other elements may be further included.

Also, terms such as “ . . . unit”, “ . . . -er (-or)”, and “ . . . module” mean a unit that processes at least one function or operation, which may be divided into hardware, software, or a combination of the two.

In addition, the term “at least one” is defined as a term including the singular and the plural, and even if the term “at least one” does not exist, it is apparent that each element may exist in the singular or plural and may mean the singular or plural.

In addition, the fact that each component is provided in singular or plural may be changed according to embodiments.

Hereinafter, a preferred embodiment of a deep reinforcement learning apparatus and method for a pick-and-place system according to an embodiment of the present disclosure will be described in detail with reference to the accompanying drawings.

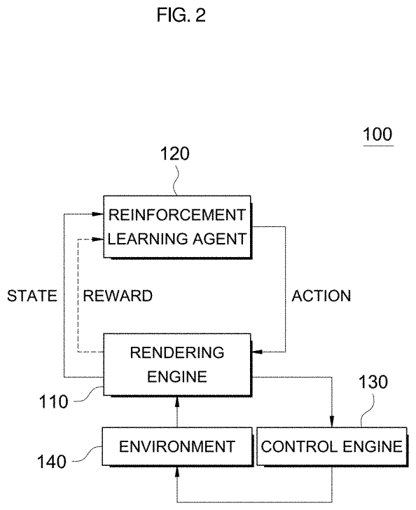

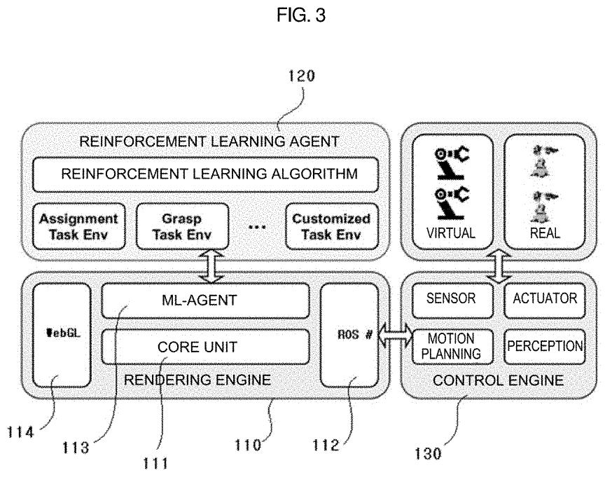

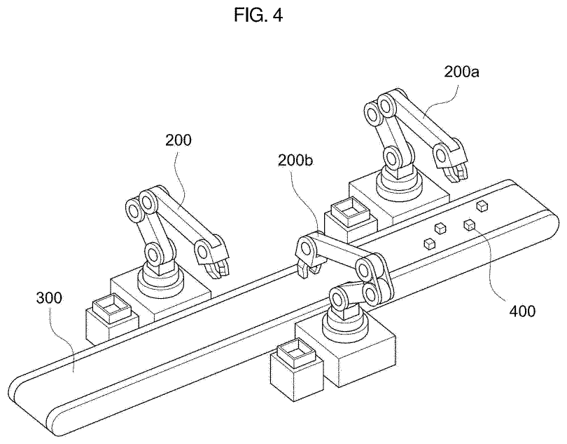

FIG. 2 is a block diagram schematically illustrating a deep reinforcement learning apparatus for a pick-and-place system according to an embodiment of the present disclosure, FIG. 3 is a block diagram illustrating the configuration of the deep reinforcement learning apparatus for the pick-and-place system according to the embodiment of FIG. 2, and FIG. 4 is an exemplary diagram illustrating the pick-and-place system of the deep reinforcement learning apparatus for the pick-and-place system according to the embodiment of FIG. 2.

Referring to FIGS. 2 to 4, the deep reinforcement learning apparatus 100 for the-pick-and-place system according to an embodiment of the present disclosure uses a robot operating system (ROS) in a real-time environment to make pick-and-place-related decisions. To this end, the deep reinforcement learning apparatus 100 may constitute a simulation learning framework to generate a stable path motion that meets a variety of hardware and real-time constraints so that reinforcement learning can be applied, and may include a rendering engine 110, a reinforcement learning agent 120, a control engine 130, and an environment 140.

The rendering engine 110 is a component that generates a pick-and-place environment, and may perform a simulation based on the movement path of robots 200, 200a, and 200b, that is, a trajectory according to a pick-and-place operation.

In addition, the rendering engine 110 transmits state information to be used for reinforcement learning and reward information based on a simulation to the reinforcement learning agent 120 to request an action.

Accordingly, the reinforcement learning agent 120 provides the requested action to the rendering engine 110.

In addition, the rendering engine 110 may include a core unit 111 to simulate the kinematics of an object 400 realistically and physically, and may also include a simulator to which a physics engine is applied.

Here, the state may be the current state of the robots 200, 200a, and 200b or the position of the object, and includes the maximum number of the objects and the position of the object that the robots 200, 200a, and 200b can currently pick up.

In addition, the reward may be divided into a case of successfully picking up the object as the position of the object is changed, and a case of not grabbing the object even though the robot's path was planned.

In addition, as to the reward, a reward function may include a negative value for a pick-and-place time period in order to encourage the reinforcement learning agent 120 to perform pick-and-place as soon as possible.

In addition, when the robot fails to select an object, a penalty point of, for example, “−10” may be added to the reward function.

In addition, for the action provided from the reinforcement learning agent 120, the rendering engine 110 may request a path between the parking position and placement position of the one or more robots 200, 200a, and 200b from the control engine 130.

In addition, the rendering engine 110 may provide a protocol to transmit and receive data to and from the control engine 130, and ROS #112 may be configured to transmit, to the control engine 130, a request for generating a path between the pick-up position and placement position of the object 400.

That is, ROS #112 allows the rendering engine 110 and the control engine 130 to interwork.

In addition, in the rendering engine 110, a machine learning (ML)-agent 113 may be configured to apply a reinforcement learning algorithm for training the model of the reinforcement learning agent 120.

In addition, the ML-agent may transmit information to the reinforcement learning agent 120 and may perform an interface between the simulator of the rendering engine 110 and a program such as “Python”.

In addition, the rendering engine 110 may be configured to include a web-based graphic library (WebGL, 114) to be visualized through the web.

That is, it is possible to configure the rendering engine 110 to allow interactive 3D graphics to be used in a compatible web browser using the JavaScript programming language.

The reinforcement learning agent 120 is a component that determines an action so that the movement of the robots 200, 200a, and 200b is optimized based on an episode using state information and reward information, and may be configured to include a reinforcement learning algorithm.

Here, the episode constitutes the environment 140 in which the robots 200, 200a, and 200b perform a pick-and-place operation on the moving object 400 while a conveyor belt 300 operates, and the reinforcement learning agent 120 selects the object 400 to be picked up and configures the number of successfully picked objects reaching a target as one episode.

In addition, the reinforcement learning algorithm may use either a value-based approach or a policy-based approach to find an optimal policy for maximizing the reward.

In the value-based approach, the optimal policy is derived from an optimal value function approximated based on the agent's experience, and in the policy-based approach, the optimal policy separated from the value function approximation is trained and the trained policy is improved in a direction of the approximate function.

In this embodiment, a proximal policy optimization (PPO) algorithm, that is, a policy-based algorithm is used.

When the PPO algorithm is used, the policy is improved through an increase in a slop without moving away from the current policy so that policy improvement is more stably achieved, and policy improvement can be achieved by maximizing goals.

In addition, the reinforcement learning agent 120 determines an action of assigning information indicating whether to pick up an arbitrary object to a specific robot through the current state of the robots 200, 200a, and 200b performing pick-and-place and information on the selectable objects 400 on the conveyor belt 300.

In addition, the reinforcement learning agent 120 may perform a delayed reward processing in response to a delayed reward.

In addition, the reinforcement learning agent 120 may include two multiple layer perceptrons (MLPs) behind a input state for feature extraction, and may include a long short term memory (LSTM) layer to consider the uncertainty in the simulation and the moving object 400.

In other words, it is possible to perform learning of long-term dependencies between steps in time series and sequence data and to improve a gradient flow for long sequences.

In addition, since, in the reinforcement learning-based algorithm of the reinforcement learning agent 120, it takes less time to wait for an object that arrives at a high belt speed rather than a low belt speed, the pick-and-place time may be shortened when the belt speed is increased regardless of the belt speed by learning to select an entity with the highest probability value that will generate the shortest pick-and-place time period.

Meanwhile, the total planning time and robot execution time, which are expressed as the pick-and-place time period, may be uncertain due to uncertainties in the planner's computing time, the object's arrival probability, and the robot's execution time (real-time hardware constraints).

Since this can influence object assignment determination for each robot, it is possible to provide the reinforcement learning algorithm that trains an agent to adaptively select an object under such uncertainty.

Therefore, the reinforcement learning algorithm enables the learning of the reinforcement learning agent 120 that controls the system to satisfy various aspects such as minimizing the pick-and-place time period and maximizing the number of selected objects.

The control engine 130 is a component that controls the robots 200, 200a, and 200b to move based on the action and extracts and provides path information according to the movement of the corresponding robots 200, 200a, and 200b, and may be configured to include a robot control system (ROS).

Here, path information according to the movement of the robots 200, 200a, and 200b may be, for example, a path in which the robots 200, 200a, and 200b move in an actual environment in which the object 400 moving along the conveyor belt 300 is picked and placed.

In addition, the robot control system (ROS) enables the movement of the robot to be applied on the simulator by using robot manipulation and path planning, and enables an operation controlled using the ROS to be applied not only in simulation but also in the real environment.

In addition, the path information according to the movement of the robots 200, 200a, and 200b may be a path moved by the robots 200, 200a, and 200b on a pre-stored simulator program.

In addition, the control engine 130 may control the robots 200, 200b, and 200b to operate using predetermined path planning information of the robots 200, 200a, and 200b.

In addition, the control engine 130 may generate a path using an open motion planning library by using a Movelt package, which is an integrated library for a manipulator.

That is, the control engine 130 searches for a valid path (e.g., a smooth and collision-free path) between an initial joint angle and a target joint angle.

In addition, the manipulator is disposed along the moving conveyor belt, and may be a robot that repeatedly performs a pick-and-place operation.

In addition, the control engine 130 may generate four paths, each corresponding to four planning steps, instead of generating a long path from the current position to the picking position and from the picking position to the placement position.

That is, the control engine 130 may acquire four trajectories through a “preliminary identification process” of generating a path from the current position to, for example, a standby position (or the same position) where the robot's gripper is positioned on the target object 400, a “identification process” for generating a path from the standby position to the parking position when the object arrives, a “pickup process” for generating a path to lift the gripper back to its standby position, and a “place process” for generating a path from the standby position to the placement position.

The environment 140 may be a single robot environment or a multi-robot environment.

The conveyor belt 300 is aligned along a certain direction and may have an arbitrary width (e.g., 30 cm), and the robots 200, 200a, and 200b may reach all areas along the width.

The object 400 may be started on one side (e.g., the right side) of the conveyor belt 300 at a speed according to the adjustable speed of the conveyor belt 300, and new objects may arrive randomly at any location and time interval.

In addition, the object 400 may be configured in the form of a cube of a predetermined size so that the object 400 can be easily picked up.

Hereinafter, a deep reinforcement learning method for a pick-and-place system according to an embodiment of the present disclosure will be described.

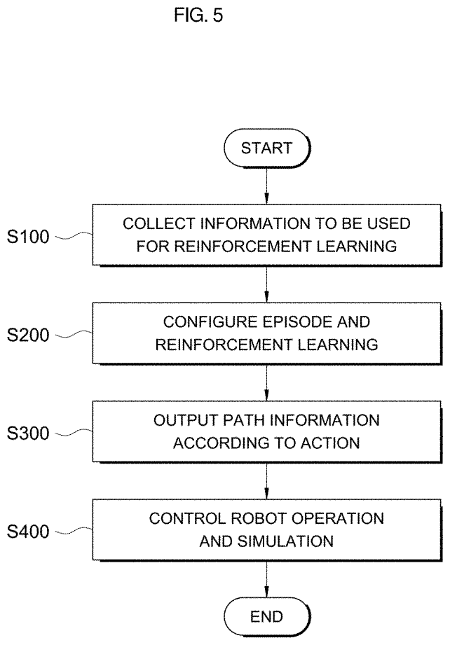

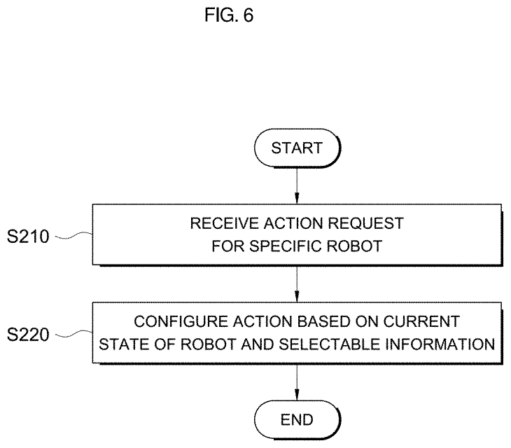

FIG. 5 is a flowchart illustrating a deep reinforcement learning method for a pick-and-place system according to an embodiment of the present disclosure, and FIG. 6 is a flowchart illustrating an episode configuration process of a deep reinforcement learning method for a pick-and-place system according to the embodiment of FIG. 5.

Referring to FIGS. 2 to 6, in an embodiment of the present disclosure, in a deep reinforcement learning method for a pick-and-place system, the rendering engine 110 requests and collects, when the reinforcement learning agent 120 requests state information and reward information for an action to be used for reinforcement learning from the rendering engine 110, the state information and the reward information from the control engine 130 in operation S100.

In addition, the information collected in operation S100 may be movement information of the robots 200, 200a, and 200b including a path between the parking position and placement position of one or more robots 200, 200a, and 200b.

In addition, the state information and reward information collected in operation S100 are provided to the reinforcement learning agent 120, and the reinforcement learning agent 120 configures an action such that the movements of the robots 200, 200a, and 200b are optimized based on the state information and the reward information, in operation S200.

Here, the reinforcement learning agent 120 may take the action from an individual set of n selections according to the number of consecutive entities, and may calculate the selected position based on the current entity position, the belt speed, the current joint angle, etc., after selecting the entity.

In addition, in operation S200, the reinforcement learning agent 120 determines to select and pick up which object 400 in the environment 140 in which the robots 200, 200a, and 200b perform a pick-and-place operation on the moving object 400 while the conveyor belt 300 operates, and configures the number of successfully picked objects to reach the target as one episode.

In addition, in operation S200, the reinforcement learning agent 120 determines an action of assigning information indicating whether to pick up an arbitrary object to a specific robot based on the current state of the robots 200, 200a, and 200b performing pick-and-place and information of the selectable objects 400 on the conveyor belt 300.

That is, when the action request for the specific robot is received in operation S210, reinforcement learning may be performed by configuring the action based on the current state and selectable information of the robot in operation S220.

In addition, in operation S200, the reinforcement learning agent 120 may perform a delayed reward processing in response to a delayed reward.

Subsequently, in operation S300, the rendering engine 110 receives the action determined in operation S200 and outputs the received action to the control engine 130.

In operation S400, the control engine 130 controls the robots 200, 200a, and 200b to move based on the action generated in operation S200.

In operation S400, the control engine 130 controls the robots 200, 200a, and 200b, in which the operations of the robots 200, 200a, and 200b based on the action are interlocked in the real environment, to operate, and may extract a movement path (or trajectory) corresponding thereto.

In addition, in operation S400, the control engine 130 may control the robots 200, 200a, and 200b to move based on the action on a pre-stored simulator program, and may extract a movement path corresponding to the simulator program.

In addition, in operation S400, the path information of the robots 200, 200a, and 200b may be provided to the rendering engine 110, and the rendering engine 110 may perform a process of performing simulation based on the path according to the movement of the robots 200, 200a, and 200b.

Through the simulation of operation S400, the rendering engine 110 divides reward for a case in which the object is successfully picked up as the position of the object is changed and reward for a case where the object is not picked up even though the robot's path is planned, and provides the divided rewards to the reinforcement learning agent 120.

The following is an experimental result of analyzing the action of the agent through the belt speed, the placement, and various configurations of the number of robots 200, 200a, and 200b as shown in FIG. 3 for evaluation of a framework.

A metric that calculates the total work time after selecting 10 entities was used for evaluation of the framework.

Table 1 shows the total operating time of the proposed algorithm for three reference algorithms as the evaluation results.

TABLE 1

| | Belt | Posi- | | | | Proposed |
|---|---|---|---|---|---|---|
| Robot | speed | tion | Random (s) | FSFP(s) | SP(s) | algorithm |
| One | 0.025 | left | 125 | 118.7 | 118.5 | 118.7 |
| robot | | | | | | |
| One | 0.05 | left | 102.6 | 88.7 | 88.6 | 88.7 |
| robot | | | | | | |
| One | 0.1 | left | 94 | 75.4 | 75.7 | 75.4 |
| robot | | | | | | |
| One | 0.1 | Right | 90.8 | 85.1 | 77.2 | 74 |
| robot | | | | | | |
| Two | 0.1 | — | 79.3 | 69 | 66 | 61.7 |
| robots | | | | | | |
| Three robots | 0.1 | — | 55.2 | 45.5 | 45.5 | 45.2 |

Here, random denotes selecting an entity at random, first see first pick (FSFP) denotes always selecting the first entity from a list of observable entities, and a shortest path (SP) denotes selecting the entity closest to the robot.

It can be seen that an agent trained with an algorithm composed of one robot system tries to adapt to all situations, and its performance is improved by 15%, 2.9%, and 2.9%, respectively, compared to random, FSFP, and SP.

In addition, it can also be improved from the fact that a rule-based algorithm does not take into account path planning that depends on the hardware constraints and the computing time of the planner.

In addition, the reinforcement learning-based algorithm performs learning so that the agent can select the entity that is most likely to produce the shortest pick-and-place time period, whereby the pick-and-place time can be shortened by increasing the belt speed regardless of the belt speed.

This is because it takes less time to wait for an object that arrives at a high belt speed rather than a low belt speed.

In addition, the placement position may affect the agent action.

In particular, when the placement is on the left of the robot, the agent action always converges to an FSFP agent which selects the leftmost entity closest to the placement (e.g., the shortest path to the placement position).

In addition, the agent placed on the right side of the robot learns a policy in which FSFP and SP are mixed. In particular, the agent selects the first arrived entity (FSFP operation) in the first determination and selects the closest entity (usually the second or third entity) closest to the operation of the SP agent in the next determination.

When multiple robot systems are used, the pick-and-place time may be reduced by increasing the number of robots.

Therefore, it is possible to configure a simulation learning framework to apply reinforcement learning to make pick-and-place-related decisions using the ROS in a real-time environment, thereby generating stable path motion that meets various hardware and real-time constraints.

In addition, it is possible to activate action-based systems, identify the feasibility and scalability of conveyor belt-based systems, and extend the framework to various robot systems to use reinforcement learning algorithms.

In addition, by taking into account the uncertainty in the simulation and moving objects, it is possible to improve a more realistic environment for the system.

As described above, although described with reference to preferred embodiments of the present disclosure, it is understood that those skilled in the art can variously modify and change the present disclosure within the scope without departing from the spirit and scope of the present disclosure described in the claims below.

In addition, the reference numbers described in the claims of the present disclosure are only described for clarity and convenience of description, and are not limited thereto, and in the process of describing the embodiment, the thickness of the lines shown in the drawings or the sizes of components, etc., may be exaggerated for clarity and convenience of explanation.

In addition, the above-mentioned terms are terms defined in consideration of functions in the present disclosure, which may vary depending on the intention or custom of the user or operator, so the interpretation of these terms should be made based on the content throughout this specification.

In addition, although it is not explicitly shown or described, it is apparent that those skilled in the art may make various forms of modifications including the spirit of the present disclosure from the description of the present disclosure, and this still falls within the scope of the present disclosure.

In addition, the embodiments described above with reference to the accompanying drawings are described for illustrative purposes, and the scope of the present disclosure is not limited to the embodiments.

### Description of Reference Numerals

100: reinforcement learning apparatus
110: rendering engine
111: core unit
120: ROS #
113: ML-agent
114: WebGL
120: reinforcement learning agent
130: control engine
140: environment
200, 200a, and 200b: robots
300: conveyor belt
400: object

What is claimed is:

1. A deep reinforcement learning apparatus for a pick-and-place system, the deep reinforcement learning apparatus comprising:
a rendering engine (110) configured to perform simulation based on a received path according to the movement of one or more robots (200, 200a, and 200b) while requesting a path between the parking position and placement position of the robots (200, 200a, and 200b) with respect to a provided action and to provide state information and reward information to be used for reinforcement learning;
a reinforcement learning agent (120) configured to perform deep reinforcement learning based on an episode using the state information and reward information provided from the rendering engine (110) to determine an action so that the movement of the robots (200, 200a, and 200b) is optimized; and
a control engine (130) configured to control the robots (200, 200a, and 200b) to move based on the action and to provide path information according to the movement of the robots (200, 200a, and 200b) to the rendering engine (110) in response to the request of the rendering engine (110),
wherein the reinforcement learning agent (120) determines an action for assigning information indicating whether to pick up an arbitrary object to a specific robot through current states of the robots (200, 200a, and 200b) and information of selectable objects (400).

2. The deep reinforcement learning apparatus of claim 1, wherein the path information according to the movement of the robots (200, 200a, and 200b) is any one of a path in which the robots (200, 200a, and 200b) move in a real environment and a path in which the robots (200, 200a, and 200b) move in a pre-stored simulator program.

3. The deep reinforcement learning apparatus of claim 1, wherein, in the rendering engine (110), an application program to perform visualization through a web is additionally installed.

4. The deep reinforcement learning apparatus of claim 1, wherein the reinforcement learning agent (120) performs a delayed reward processing in response to a delayed reward.

5. The deep reinforcement learning apparatus of claim 1, wherein the reinforcement learning agent (120) includes a long short term memory (LSTM) layer for considering the uncertainty in the simulation and the moving object (400).

6. The deep reinforcement learning apparatus of claim 1, wherein the reinforcement learning agent (120) learns to select an entity with a probability value that will generate the shortest pick-and-place time period.

7. A deep reinforcement learning method for a pick-and-place system, the deep reinforcement learning method comprising:
a) requesting and collecting, by a reinforcement learning agent (120), state information and reward information on an action to be used for reinforcement learning from a rendering engine (110);
b) performing, by the reinforcement learning agent (120), deep reinforcement learning based on an episode using the collected state information and reward information to determine an action so that the movement of one or more robots (200, 200a, and 200b) is optimized;
c) controlling, by a control engine (130), the robots (200, 200a, and 200b) to move based on the action when the rendering engine (110) outputs the determined action; and
d) receiving, by the rendering engine (110), path information of the robots (200, 200a, and 200b) to perform simulation based on a path according to the movement,
wherein the b) performing of the deep reinforcement learning includes determining an action for assigning information indicating whether to pick up an arbitrary object to a specific robot through current states of the robots (200, 200a, and 200b) and selectable objects (400).

8. The deep reinforcement learning method of claim 7, wherein the information collected in the a) requesting and collecting of the state information and reward information is movement information of the robots (200, 200a, and 200b) including a path between the parking position and placement position of the robots (200, 200a, and 200b).

9. The deep reinforcement learning method of claim 7, wherein the b) performing of the deep reinforcement learning includes performing a delayed reward processing in response to a delayed reward.

10. The deep reinforcement learning method of claim 7, wherein the b) performing of the deep reinforcement learning includes selecting, by the reinforcement learning agent (120), an entity with a probability value that will generate the shortest pick-and-place time period.

11. The deep reinforcement learning method of claim 7, wherein the c) controlling of the robots (200, 200a, and 200b) includes controlling, by the control engine (130), the robots (200, 200a, and 200b) to move in a real environment and on a pre-stored simulator program and extracting a movement path corresponding to the simulator program.
